(19) United States
(12) Patent Application Publication
(10) Pub. No.: US 2016/0058091 A1
(43) Pub. Date: Mar. 3, 2016

(54) MOUNTING DEVICE AND IMAGING DEVICE

(71) Applicant: Sony Corporation, Tokyo (JP)

(72) Inventors: Yuuji Sasaki, Tokyo (JP); Osamu Mizukami, Kanagawa (JP); Masashi Jimbo, Tokyo (JP); Mokuyoh Nakano, Tokyo (JP); Soichi Tanaka, Kanagawa (JP)

(21) Appl. No.: 14/471,235

(22) Filed: Aug. 28, 2014

(51) Int. Cl. A42B 3/04; H04N 5/225

(52) U.S. Cl. CPC A42B 3/0406; H04N 5/2253

(57) ABSTRACT

Provided is a mounting device that includes: an attachment section configured to be detachably attached to an ear opening of a shell of a helmet; and a holder section configured to be connected to the attachment section, the holder section being configured to detachably hold an object to be mounted.

### BACKGROUND

The present disclosure relates to a mounting device to allow an imaging section to be mounted on a helmet, and an imaging device including the mounting device.

A small-sized video camera called “an action camera” or “a sports camera” is attachable to various objects such as vehicles typified by bicycles or motorbikes, surfboards, helmets, and human or animal bodies, and is used in taking moving pictures or still images that involve rapid motions like sports.

### SUMMARY

In some cases, photographing with a camera attached to a helmet involves complicated work, e.g., fixing a camera to a helmet with a double-sided tape or an adhesive tape and so on, and peeling off the double-sided tape or the adhesive tape and so on to detach the camera after photographing is finished.

It is desirable to provide a mounting device that makes it possible to facilitate mounting and dismounting an object to be mounted, and an imaging device including the mounting device.

According to an embodiment of the present disclosure, there is provided a mounting device including: an attachment section configured to be detachably attached to an ear opening of a shell of a helmet; and a holder section configured to be connected to the attachment section, the holder section being configured to detachably hold an object to be mounted.

According to an embodiment of the present disclosure, there is provided an imaging device including: an imaging section; and a mounting section, wherein the mounting section includes an attachment section configured to be detachably attached to an ear opening of a shell of a helmet; and a holder section configured to be connected to the attachment section, the holder section being configured to detachably hold the imaging section.

In the mounting device and the imaging device according to the above-described embodiments of the present disclosure, in photographing, the attachment section is attached to the ear opening of the shell of the helmet, and the holder section is allowed to hold the object to be mounted, for example, an imaging section. When photographing is finished, the attachment section is detached from the ear opening of the shell of the helmet.

According to the mounting device and the imaging device in the above-described embodiments of the present disclosure, since the attachment section is detachably attached to the ear opening of the shell of the helmet, and the holder section is allowed to hold the object to be mounted, for example, an imaging section, it is possible to facilitate mounting and dismounting the object to be mounted.

It is to be noted that some effects described here are not necessarily limitative, and any of other effects described herein may be achieved.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a perspective view illustrating an imaging device according to an embodiment of the present disclosure, in a state where the imaging device is mounted on a helmet, viewed obliquely from the left front side of the helmet.

FIG. 2 is a perspective view illustrating an imaging section illustrated in FIG. 1, viewed from the front of the imaging section.

FIG. 3 is a perspective view illustrating the imaging section illustrated in FIG. 1, viewed from the rear of the imaging section.

FIG. 4 is a perspective view illustrating an overall configuration of the mounting section illustrated in FIG. 1.

FIG. 5 is a top view illustrating a configuration of the attachment section illustrated in FIG. 1.

FIG. 6 is a perspective view illustrating a configuration of a first catching member and a holder section illustrated in FIG. 1.

FIG. 7 is a perspective view illustrating the first catching member illustrated in FIG. 6.

FIG. 8 is a top view illustrating the first catching member illustrated in FIG. 6.

FIG. 9 is a side view illustrating an example of engagement of the first catching member illustrated in FIG. 7 with an ear opening.

FIG. 10 is a side view illustrating another example of engagement of the first catching member illustrated in FIG. 7 with the ear opening.

FIG. 11 is a side view illustrating still another example of engagement of the first catching member illustrated in FIG. 7 with the ear opening.

FIG. 12 is a side view illustrating still another example of engagement of the first catching member illustrated in FIG. 7 with the ear opening.

FIG. 13 is a perspective view illustrating an example of a configuration of a joint part in the holder section illustrated in FIG. 6.

FIG. 14 is a cross-sectional view illustrating a configuration of the joint part illustrated in FIG. 13.

FIG. 15 illustrates horizontal alignment of the imaging section mounted on a mounting base of the holder section illustrated in FIG. 13.

FIG. 16 illustrates adjustment of a position of the imaging section in a rotating direction, by the holder section illustrated in FIG. 13.

FIG. 17 is an exploded view, in perspective, illustrating an example of the mounting base in the holder section illustrated in FIG. 1

FIG. 18 is a perspective view illustrating an overall configuration of a mounting section according to a modification example 1.

FIG. 19 is a perspective view illustrating an imaging device including the mounting section illustrated in FIG. 18, in a state where the imaging device is mounted on a helmet, viewed obliquely from the right front side of the helmet.

FIG. 20 is a plan view illustrating an example of a configuration of a receiving part of the first catching member according to a modification example 3.

FIG. 21 is a perspective view illustrating an overall configuration of the first catching member and the holder section in the mounting section according to a modification example 4.

FIG. 22 is a perspective, partly broken, view illustrating the joint part in the holder section illustrated in FIG. 21.

FIG. 23 is a perspective view illustrating a modification example of the joint part in the holder section according to the modification example 4.

FIG. 24 is a perspective view illustrating a configuration of the first catching member and the holder section in the mounting section according to a modification example 5.

FIG. 25 is a perspective view illustrating a modification example of the receiving part of the first catching member illustrated in FIG. 24.

FIG. 26 is a perspective view illustrating an overall configuration of the mounting section according to a modification example 6.

FIG. 27 is a front elevational view of a mounting device according to one embodiment of the disclosure.

FIG. 28 is a rear elevational view of the mounting device illustrated in FIG. 27.

FIG. 29 is a right side elevational view of the mounting device illustrated in FIG. 27.

FIG. 30 is a left side elevational view of the mounting device illustrated in FIG. 27.

FIG. 31 is a top plan view of the mounting device illustrated in FIG. 27.

FIG. 32 is a bottom plan view of the mounting device illustrated in FIG. 27.

FIG. 33 is a perspective view of the mounting device illustrated in FIG. 27.

### DETAILED DESCRIPTION

In the following, some embodiments of the present disclosure will be described in detail with reference to the accompanying drawings. It is to be noted that description will be made in the following order.

1. Embodiment (one example in which a first catching member engages a first ear opening on the left side, a second catching member engages a second ear opening on the right side, and an imaging section is held on the left side of a helmet)

2. Modification Example 1 (one example in which the first catching member engages the second ear opening on the right side, the second catching member engages the first ear opening on the left side, and the imaging section is held on the right side of the helmet)

3. Modification Example 2 (examples of alternatives to a hook-and-loop fastener as the connecting member)

4. Modification Example 3 (one example in which a plurality of first catching members having receiving parts of different shapes are used to allow a position of the object to be mounted to be adjustable in a front-and-rear direction)

5. Modification Example 4 (one example in which a joint part is configured of a flexible tube)

6. Modification Example 5 (one example in which a video dowel of a mounting base is omitted)

7. Modification Example 6 (one example in which imaging sections are held both on the right side and on the left side of the helmet)

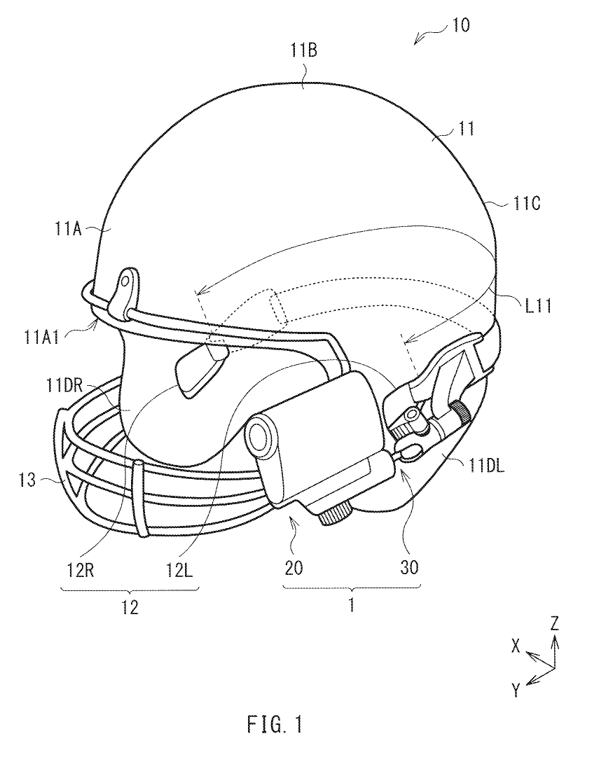

FIG. 1 illustrates an overall configuration of an imaging device 1 according to an embodiment of the present disclosure. The imaging device 1 is, for example, mounted for use on a helmet 10 for sports such as football, and includes an imaging section 20 and a mounting section 30. It is to be noted that since a mounting device according to an embodiment of the present disclosure is embodied by the mounting section 30 of the imaging device 1, they are described together.

In this example embodiment, description is given on a case that, for example, the imaging device 1 is for the use of photographing football. Participants in football record moving pictures of practice and review the moving pictures trying to improve their techniques. Participants in football wear various protective equipments such as the helmet 10 as described below. The imaging device 1 is mounted on the helmet 10 for use.

The helmet 10 is intended for protecting the head of a wearer, and is, for example, a football helmet including a shell 11, a shock absorbing member (not illustrated), and a face guard 13. The shell 11 is configured of a plastic material having strength and shock resistivity. The shell 11 has a substantially semispherical shape including a front portion 11A, a crown portion 11B, a rear portion 11C, a right side portion 11DR, and a left side portion 11DL. The right side portion 11DR and the left side portion 11DL extend downward below a front edge line 11A1 of the front portion 11A to cover a region from the temple to the cheek of a wearer. The shock absorbing member (not illustrated) is arranged on an inner surface of the shell 11. The face guard 13 is fixed to an opening surrounded by the front portion 11A, the right side portion 11DR, and the left side portion 11DL of the shell 11.

The shell 11 is provided with an ear opening 12. The ear opening 12 includes a first ear opening 12L and a second ear opening 12R. The first ear opening 12L is provided in the left side portion 11DL of the shell 11. The second ear opening 12R is provided in the right side portion 11DR of the shell 11.

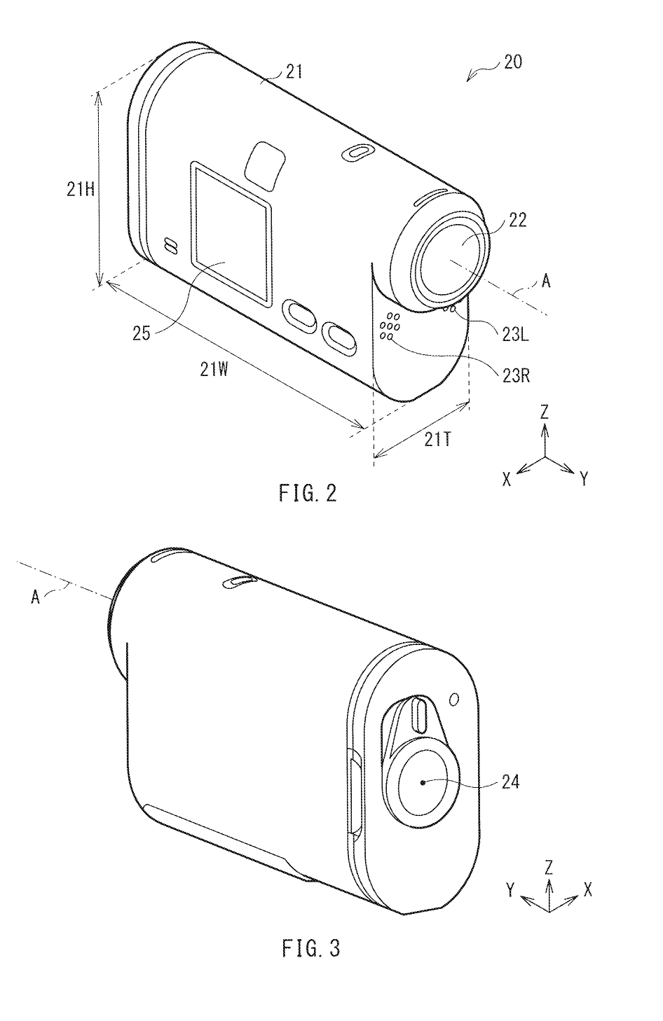

FIGS. 2 and 3 illustrate a configuration of the imaging section 20 viewed from the front and the rear thereof, respectively. The imaging section 20 is a small-sized video camera called “an action camera” or “a sports camera,” and includes, for example, a main body 21, a lens 22, microphones 23R and 23L, a recording button 24, and a display panel 25.

The main body 21 has a flat shape in which, for example, a thickness 21T is smaller than a width 21W and a height 21H, and the width 21W is larger than the height 21H. The lens 22 and the microphones 23R and 23L are provided on a front face of the main body 21. The recording button 24 is provided on a rear face of the main body 21. The display panel 25 is provided on a side face of the main body 21. It is to be noted that an arrangement on the main body 21 of the lens 22, the microphones 23R and 23L, the recording button 24, and the display panel 25 is not limited to the above-mentioned example.

Inside the main body 21, an optical system and an image pickup element (both not illustrated) are disposed behind the lens 22 on the back side of the lens 22. The image pickup element is configured to take an image of an object formed by the lens 22 and the optical system, and is configured of a CCD (Charge Coupled Device), a CMOS (Complementary Metal Oxide Semiconductor) image sensor, or the like. The display panel 25 has an interface function to allow a monitoring image during photographing, a reproduced image, a GUI (Graphical User Interface) image and so on to be displayed thereon, and is configured of, for example, a liquid crystal display panel or an organic EL (Electroluminescence) panel. The imaging section 20 preferably has, for example, a wireless communication function by NFC (Near Field Communication). The imaging section 20 preferably has, at an appropriate position of the main body 21, a sign to allow the NFC connection to be established when a user hangs the imaging section 20 over another device.

It is to be noted that the shape of the imaging section 20, i.e. the small-sized video camera, is not limited to an example illustrated in FIGS. 2 and 3. For example, FIGS. 2 and 3 illustrate a case that the lens 22 is positioned with an optical axis A of the lens 22 being parallel to a direction of the longest dimension (the width 21W) of the main body 21. In this way, as illustrated in FIG. 1, it is possible to allow the imaging section 20 to be placed side by side with the left side portion 11DL of the shell 11 of the helmet 10, restraining the imaging section 20 from protruding sidewise from the shell 11. However, the lens 22 may be positioned with the optical axis A of the lens 22 being parallel to a direction of the shortest dimension (the thickness 21T) of the main body 21. Alternatively, the lens 22 may be positioned with the optical axis A of the lens 22 being parallel to a direction of an intermediate dimension (the height 21H) of the main body 21.

Herein, a direction of the optical axis A of the lens 22 of the imaging section 20 (a front-and-rear direction of a camera) is denoted by a Y direction; a horizontal direction (a lateral direction, a right-and-left direction) an X direction; a vertical direction (an up-and-down direction) a Z direction. The front is defined as on the object side along the direction of the optical axis A of the lens 22; the rear on the imaging section 20 side. The right and left directions are defined as viewed from the rear (from the imaging section 20 side).

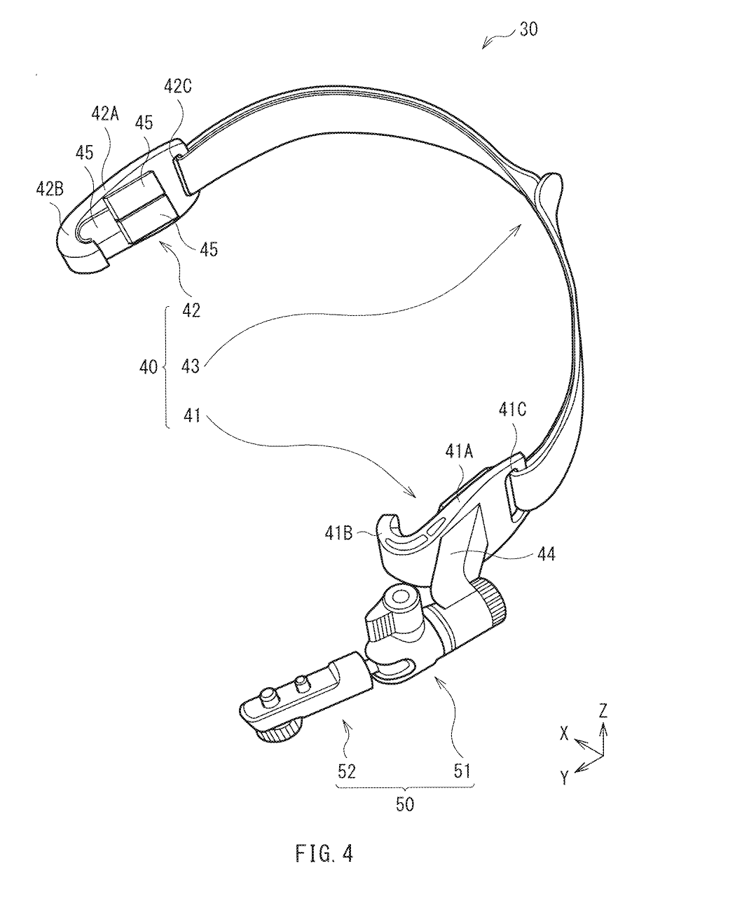

FIG. 4 illustrates an overall configuration of the mounting section 30. The mounting section 30 is configured to allow an object to be mounted, i.e. the imaging section 20 to be mounted on the helmet 10, and includes an attachment section 40 and a holder section 50. The attachment section 40 is configured to be detachably attached to the ear opening 12 of the shell 11 of the helmet 10. The holder section 50 is configured to be connected to the attachment section 40, and to detachably hold the object to be mounted, i.e. the imaging section 20. Thereby, in the imaging device 1, it is possible to facilitate mounting and dismounting the object to be mounted, i.e. the imaging section 20.

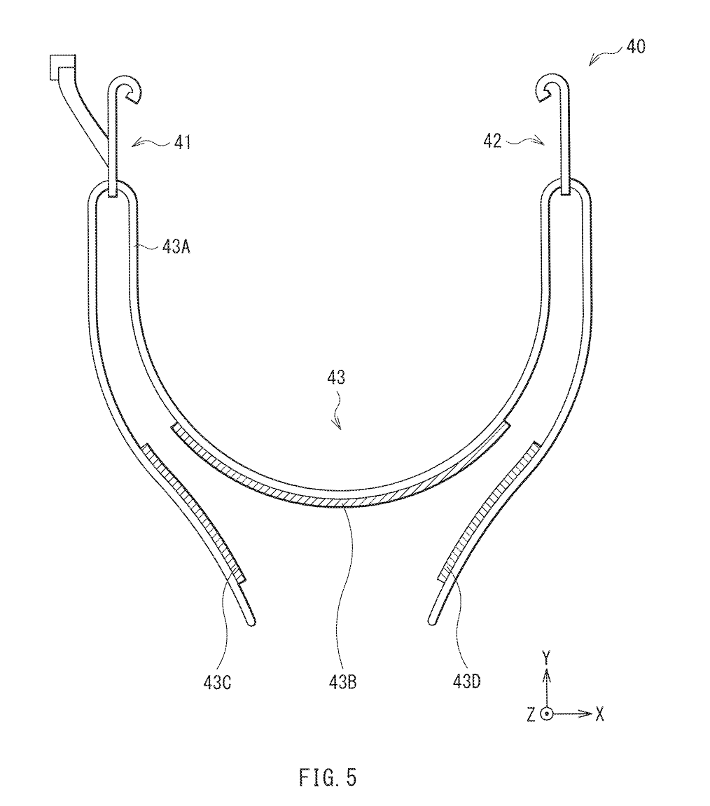

FIG. 5 illustrates a configuration of the attachment section 40. The attachment section 40 may include, for example, a first catching member 41, a second catching member 42, and a connecting member 43. The first catching member 41 may be configured to engage, for example, the first ear opening 12L. The second catching member 42 may be configured to engage, for example, the second ear opening 12R. The connecting member 43 may be configured to connect the first catching member 41 and the second catching member 42. Thus, as illustrated in FIG. 1, it is possible to extend the attachment section 40 between the first ear opening 12L and the second ear opening 12R of the shell 11, and to allow the attachment section 40 to be attached to the helmet 10 securely and firmly. It is also possible to lower a possibility of sliding or falling of the attachment section 40 due to a shock during usage. It is to be noted that, since the dimension and the shape of the ear opening 12 of the helmet 10 differ according to manufacturers, and since some helmets 10 have a protrusion or unevenness around the ear opening 12, it may be difficult in some cases to allow the attachment section 40 to be stably attached to the ear opening 12 on one side.

The connecting member 43 may preferably be configured to connect the first catching member 41 and the second catching member 42 surrounding the rear portion 11C of an outer surface of the shell 11, as illustrated in FIG. 1. This makes it possible to restrain an influence on an appearance of the helmet 10 when the imaging device 1 is mounted on the helmet 10.

The connecting member 43 may preferably be configured to be adjusted longitudinally in accordance with a route length L11 (FIG. 1) on the outer surface of the shell 11, the route length L11 being set from the first ear opening 12L to the second ear opening 12R. Thereby, it is possible to wear the imaging device 1 irrespective of a difference in size of the helmet 10 (e.g., S, M, L, XL and so on) or a difference in shape of the helmet 10 according to manufacturers. This contributes to more improved versatility of the imaging device 1. The route length L11 may preferably be a route length from the first ear opening 12L to the second ear opening 12R through the rear portion 11C of the shell 11.

Specifically, the connecting member 43 may preferably be configured to be adjusted longitudinally, for example, by about 70 mm. Since allowance of, for example, about 70 mm is made for loosening the connecting member 43, it is possible to sufficiently cope with a difference in size or in shape of various kinds of the helmets 10.

The connecting member 43 may preferably be configured of, for example, a hook-and-loop fastener. Specifically, the connecting member 43 may include a belt 43A. The belt 43A may be provided with hook-and-loop fasteners 43B, 43C, and 43D. The hook-and-loop fastener 43B may be provided on an outer surface of a longitudinal center portion of the belt 43A. The hook-and-loop fasteners 43C and 43D may be provided on an inner surface of both of longitudinal end portions of the belt 43A. One of the longitudinal end portions of the belt 43A may be inserted through a link part 41C (to be described later) of the first catching member 41 to be folded outside. Another of the longitudinal end portions of the belt 43A may be inserted through a link part 42C (to be described later) of the second catching member 42 to be folded outside. The hook-and-loop fasteners 43C and 43D are fastened at appropriate positions of the hook-and-loop fastener 43B. Thus, a length of the connecting member 43 is allowed to be adjusted. The connecting member 43 may be configured of, for example, nylon, polypropylene, and so on.

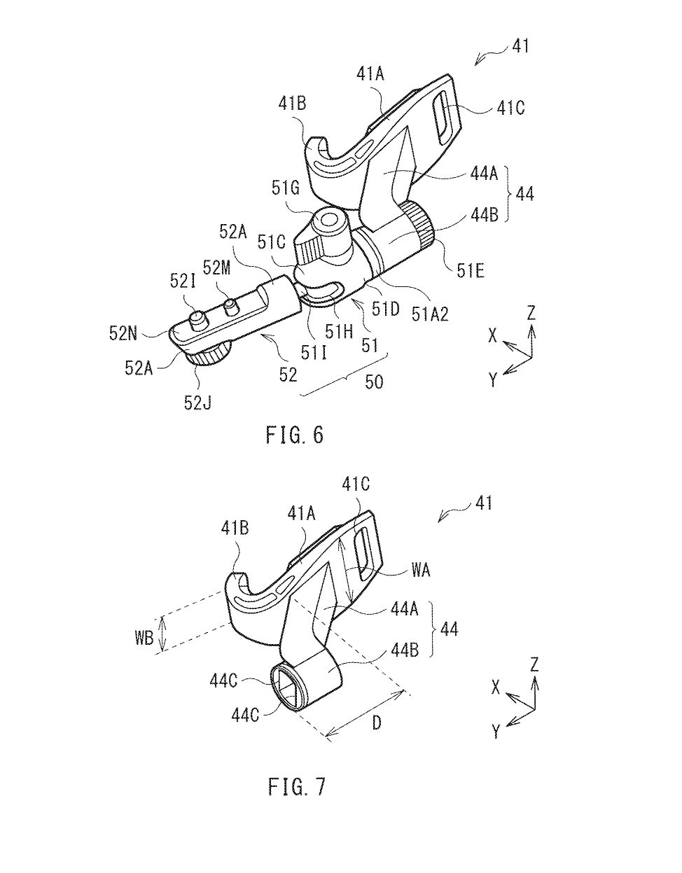

FIG. 6 illustrates a configuration of the first catching member 41 and the holder section 50. The first catching member 41 may preferably include a receiving part 44. The receiving part 44 is a part to which the holder section 50 is detachably connected. The holder section 50 may preferably include a joint part 51 and a mounting base 52. The joint part 51 is configured to be detachably connected to the receiving part 44. The mounting base 52 is a part on which the object to be mounted, i.e. the imaging section 20 is detachably mounted.

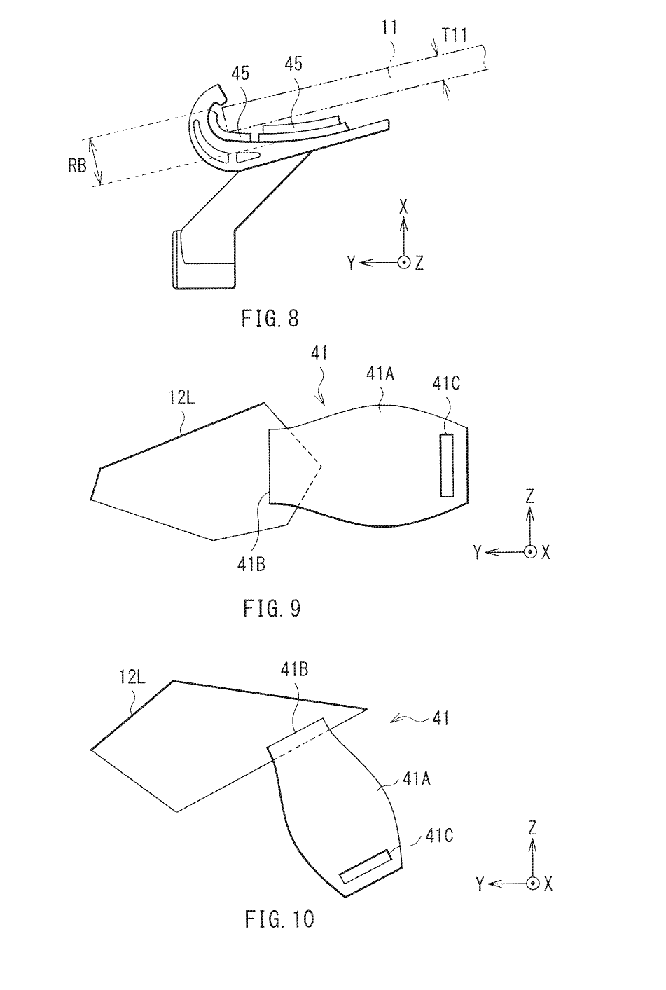

FIGS. 7 and 8 illustrate a configuration of the first catching member 41. The first catching member 41 includes, for example, a main part 41A, a hook part 41B, and a link part 41C. The main part 41A is configured of, for example, a reinforced plastic material such as polycarbonate containing glass or carbon fiber. The hook part 41B is provided in a front end of the main part 41A, and is configured to engage, for example, the first ear opening 12L. The link part 41C is provided in a rear end of the main part 41A, and is configured to allow the connecting member 43 to connect with the main part 41A. Specifically, the link part 41C is a slit that allows the connecting member 43 to be inserted through. The receiving part 44 may preferably be provided to protrude from an outer surface of the main part 41A of the first catching member 41. This makes it possible to allow the imaging section 20 held by the holder section 50 to be spaced an appropriate distance away from the helmet 10, thereby avoiding an unintended contact of the imaging section 20 with the helmet 10.

Specifically, the receiving part 44 may be formed integrally with the first catching member 41, and may include, for example, an arm portion 44A and a tubular portion 44B. The arm portion 44A may be provided to protrude from the outer surface of the main part 41A, as described above. The tubular portion 44B may be provided in a hollow cylindrical shape on an end of the arm portion 44A.

The arm portion 44A may preferably protrude diagonally forward from the outer surface of the main part 41A. Thus, it is possible to allow the holder section 50 to hold the imaging section 20 at a slightly advanced position in the front-and-rear direction Y, lowering a possibility that imaging of the face guard 13 disturbs photographing.

An amount D by which the receiving part 44 is protruded forwardly (a distance from a root of the arm portion 44A to a front end of the tubular portion 44B) may preferably be, for example, about 30 mm. Thus, it is possible to allow the lens 22 of the imaging section 20 to be substantially aligned with the eyes of a wearer P in the front-and-rear direction Y irrespective of a difference in size or in shape of the shell 11 or in arrangement of the ear opening 12. Consequently, the imaging section 20 is less likely to disturb a visual field.

The tubular portion 44B may preferably include a flat portion 44C on an inner surface. Thus, it is possible to allow the joint part 51 to be connected to the receiving part 44 easily in an appropriate orientation, preventing the imaging section 20 from being mounted with an unintended tilt. It is to be noted that the flat portion 44C may be omitted.

Further, the tubular portion 44B may preferably include a plurality of (for example, two) flat portions 44C, and the plurality of flat portions 44C may preferably be provided at rotational symmetric positions (for example, at facing positions in the circumferential direction). The reason will be explained later in a modification example 1.

The second catching member 42 is configured similarly to the first catching member 41 except that the receiving part 44 is not provided. Specifically, the second catching member 42 includes, for example, a main part 42A, a hook part 42B, and a link part 42C (as illustrated in FIG. 4). The main part 42A, the hook part 42B, and the link part 42C of the second catching member 42 are configured similarly to the main part 41A, the hook part 41B, and the link part 41C of the first catching member 41, respectively.

The first catching member 41 may preferably include a cushion 45 on an inner surface of the hook part 41B and on an inner surface of the main part 41A. Similarly, the second catching member 42 may preferably include a cushion 45 on an inner surface of the hook part 42B and on an inner surface of the main part 42A (as illustrated in FIG. 4). Thus, it is possible to cope with a difference in thickness of the shell 11 to allow the hook parts 41B and 42B to stably and securely engage the first ear opening 12L and the second ear opening 12R, respectively. It is also possible to avoid damage in the shell 11 due to a direct contact of the first catching member 41 or the second catching member 42 with the shell 11. Thus, the cushion 45 may preferably have a sufficient thickness of, for example, about 3 mm.

An inside diameter RB of the hook parts 41B and 42B may preferably be larger than a thickness T11 of the shell 11 at an edge of the first ear opening 12L or the second ear opening 12R. In this way, it is possible to provide the inside diameter RB of the hook parts 41B and 42B with a margin to cope with a difference in size or in shape of the helmet 10.

A width WB of the hook parts 41B and 42B may preferably be smaller than a width WA of the main parts 41A and 42A. Thus, it is possible to allow the hook parts 41B and 42B to securely engage the first ear opening 12L and the second ear opening 12R, while maintaining strength of the main parts 41A and 42A. The shape and the dimension of the ear openings 12 differ according to manufacturers of the helmets 10; when the width WB of the hook parts 41B and 42B is too large, the hook parts 41B and 42B may be limited in coping with the ear openings 12 of various shapes and dimensions.

FIGS. 9 to 12 illustrate examples of engagement of the first catching member 41 with the first ear opening 12L. It is to be noted that engagement of the second catching member 42 with the second ear opening 12R is also similar. The illustration of the receiving part 44 is omitted in FIGS. 9 to 12.

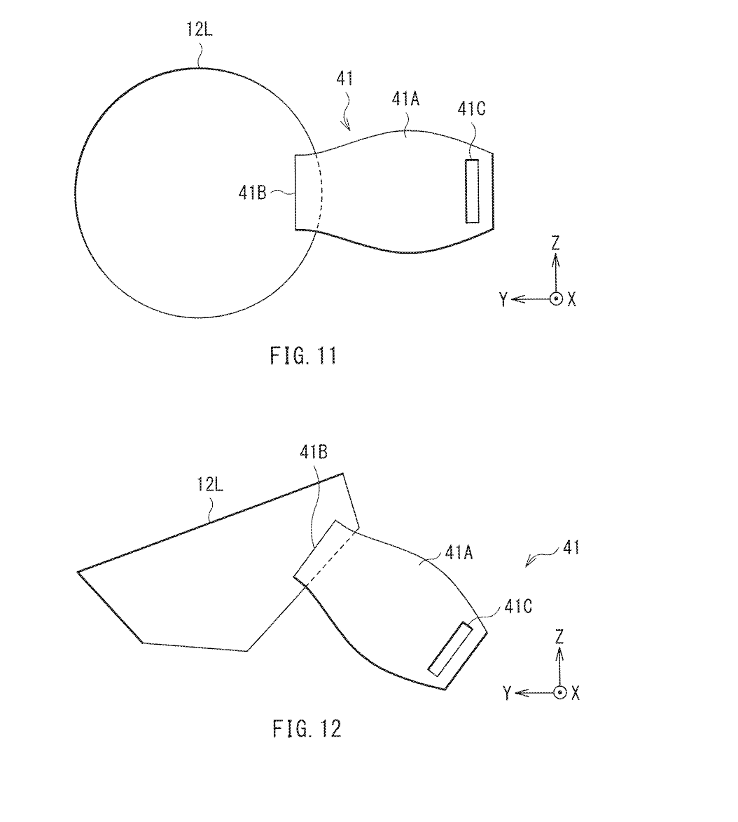

The first catching member 41 is configured to engage a rear end of the first ear opening 12L. For example, as illustrated in FIG. 9, in a case that the rear end of the first ear opening 12L forms two sides of an obtuse triangle, the first catching member 41 may engage over the two sides. For example, as illustrated in FIG. 10, in a case that the rear end of the first ear opening 12L forms two sides of an acute triangle, the first catching member 41 may engage one of the two sides, i.e. either an upper side or a lower side. For example, as illustrated in FIG. 11, in a case that the rear end of the first ear opening 12L forms a circular arc, the first catching member 41 may engage the circular arc. For example, as illustrated in FIG. 12, in a case that the rear end of the first ear opening 12L has an irregular shape, the first catching member 41 may engage an appropriate position in the irregular shape. Specifically, the first catching member 41 may engage the longest side in the irregular shape as illustrated in FIG. 12. Alternatively, the first catching member 41 may engage over two sides in the irregular shape as illustrated in FIG. 9.

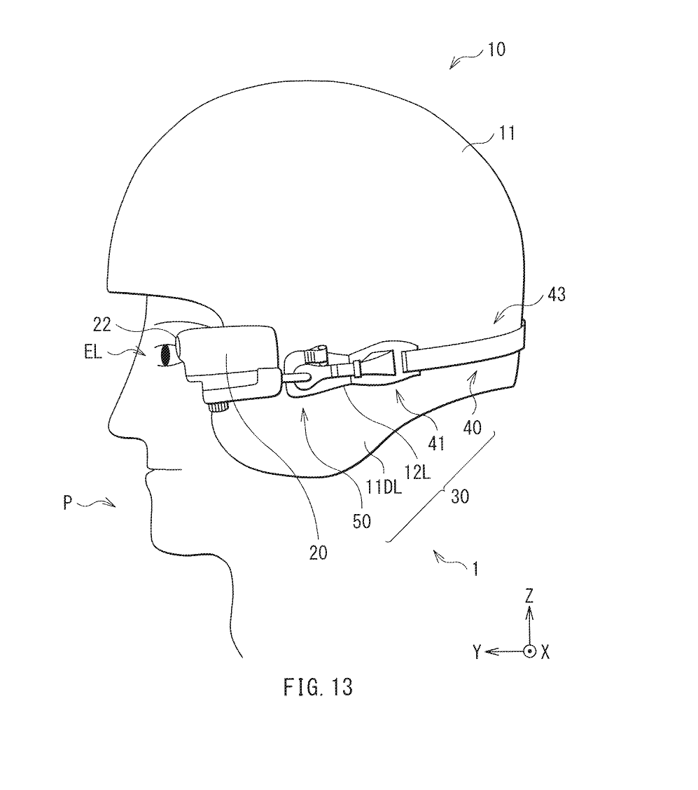

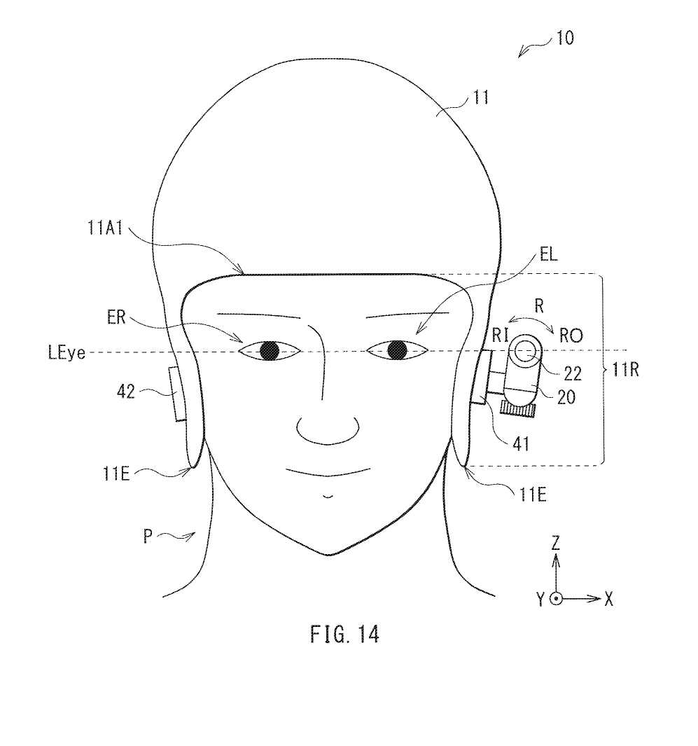

FIGS. 13 and 14 illustrate a position of the imaging section 20 held by the holder section 50. The holder section 50 may preferably hold the imaging section 20 besides the left side portion 11DL of the shell 11, that is, besides the left side of the head of the wearer P. It is to be noted that holding the imaging section 20 at the crown portion 11B (the top of the head of the wearer P), the rear portion 11C (the back of the head of the wearer P), or the front portion 11A (the forehead of the wearer P) of the shell 11 may be preferably avoided in view of protection of the wearer P.

The holder section 50 is preferably configured to hold the object to be mounted, i.e. the imaging section 20, substantially in horizontal alignment LEye with the right eye ER and the left eye EL of the wearer P of the helmet 10. More specifically, the holder section 50 is preferably configured to hold the object to be mounted, i.e. the imaging section 20, in horizontal alignment with a range 11R between the front edge 11A1 of the helmet 10 and a lower edge 11E of the helmet 10. In this way, it is possible to allow the imaging section 20 to be held in horizontal alignment with an eye level of the wearer P, thereby obtaining a picture that is close to the visual field seen by the wearer P. This makes it possible to help the wearer P or a coach to determine, based on the picture, which direction the wearer P is conscious of, when throwing or receiving a ball, which contributes to an improvement in techniques. It is to be noted that the holder section 50 may hold the imaging section 20 otherwise than as described above, i.e. in horizontal alignment LEye or in horizontal alignment with the range 11R, according to a purpose of photographing or preference of the wearer P.

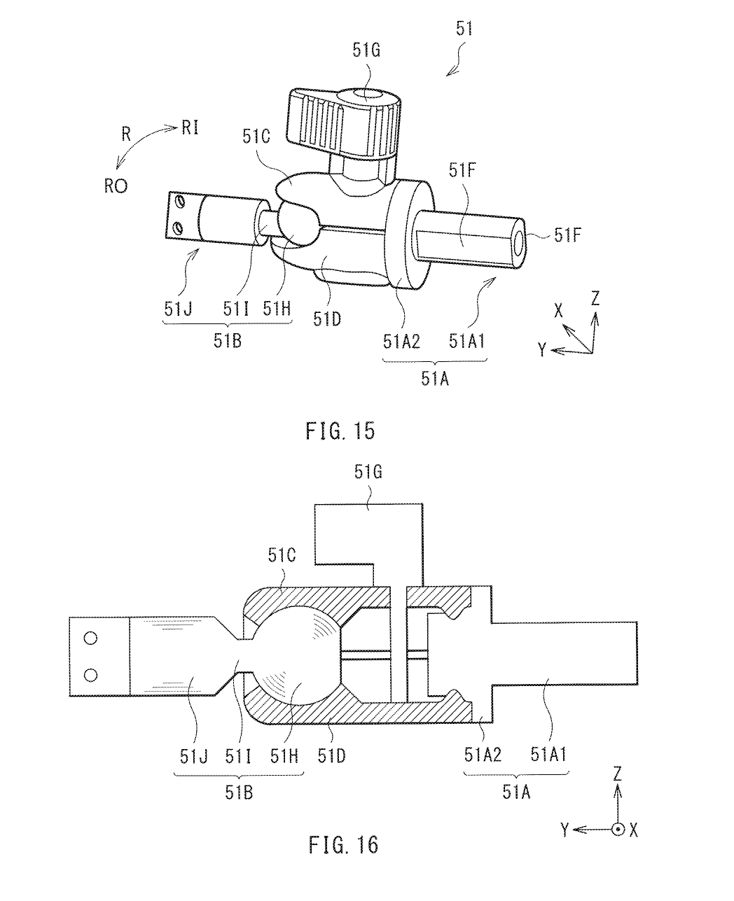

FIGS. 15 and 16 illustrate an example of a configuration of the joint part 51 in the holder section 50. The holder section 50 is preferably configured to adjust a position of the object to be mounted, i.e. the imaging section 20, in a rotating direction R relative to the joint part 51. For example, in a case that the imaging section 20 is held on the left side of the helmet 10, the visual field on the right side of the helmet 10 tends to be narrowed. Thus, as illustrated in FIG. 14, a slight tilt of the imaging section 20 outwardly in a direction of an arrow RO makes it possible to extend the visual field on the right side of the helmet 10.

Specifically, the joint part 51 includes a spindle portion 51A, an adjustment portion 51B, an upper fastening portion 51C, and a lower fastening portion 51D.

The spindle portion 51A includes, for example, a main spindle 51A1 and a flange 51A2. The main spindle 51A1 is configured to be connected to the receiving part 44. The main spindle 51A1 is configured to be inserted through the tubular portion 44B of the receiving part 44 and to be fixed to the receiving part 44 by an undepicted shaft, an undepicted screw, and a knob 51E (as illustrated in FIG. 6). The main spindle 51A1 may preferably be provided with a flat portion 51F corresponding to the flat portion 44C on the inner surface of the tubular portion 44B of the receiving part 44. The flange 51A2 is configured to be interposed between the upper fastening portion 51C and the lower fastening portion 51D and to be fixed by the fastening screw 51G.

The adjusting portion 51B includes, for example, a ball 51H, a neck 511, and a bracket 51J. The ball 51H is configured to be interposed between the upper fastening portion 51C and the lower fastening portion 51D and to be fixed by the fastening screw 51G. The bracket 51J is configured to be connected with the mounting base 52. The neck 511 connects the ball 51H and the bracket 51J. With the fastening screw 51G loosened, rolling the ball 51H between the upper fastening portion 51C and the lower fastening portion 51D allows the position of the mounting base 52 to be adjusted in the rotating direction R relative to the joint part 51. In this way, as illustrated by arrows RO and RI in FIG. 14, it is possible to allow the position of the imaging section 20 to be adjusted in the rotating direction R relative to the joint part 51.

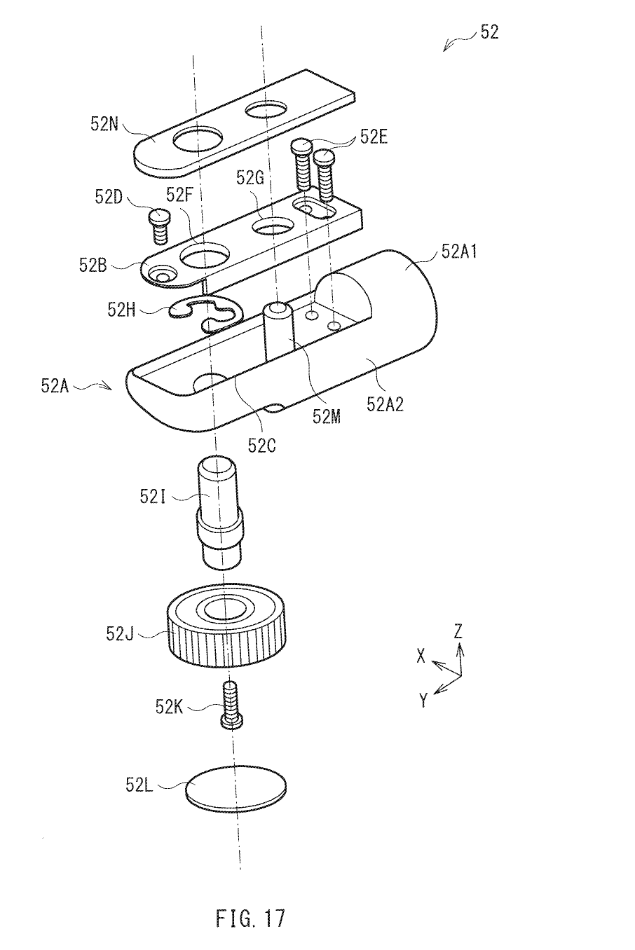

FIG. 17 illustrates the mounting base 52 in an exploded manner. The mounting base 52 includes, for example, a base 52A and a frame 52B.

The base 52A includes, for example, a cylindrical portion 52A1 and a boat-shape portion 52A2. The cylindrical portion 52A1 is configured to be connected with the bracket 51J of the adjusting portion 51B. The boat-shape portion 52A2 has a cylindrical shape with a notch 52C formed along a periphery of a cylinder. One end of the boat-shape portion 52A2 is configured to be connected with the frame 52B by a screw 52D. The other end of the boat-shape portion 52A2 is configured to be connected with the frame 52B and the bracket 51J of the adjusting portion 51B by a screw 52E.

The frame 52B is configured to cover the notch 52C of the boat-shape portion 52A2. The frame 52B is provided with two through holes 52F and 52G. To the through hole 52F, the imaging section 20 is configured to be fixed by an E ring 52H, a shaft 521, a knob 52J, a screw 52K and a sheet 52L. In the through hole 52G, a video dowel 52M is inserted. The video dowel 52M is provided for assisting alignment of the imaging section 20 when mounting and for restraining the imaging section 20 from being out of position due to a shock. The video dowel 52M is provided to stand in a bottom of the boat-like portion 52A2. A surface of the frame 52B is covered with a sheet 52N.

In the imaging device 1, in photographing, the attachment section 40 is attached to the ear opening 12 of the shell 11 of the helmet 10, and the holder section 50 is allowed to hold the object to be mounted, i.e. the imaging section 20. In the imaging section 20, an image of an object formed by the lens 22 and the optical system (not illustrated) is taken by the image pickup element (not illustrated). The image thus taken is displayed on the display panel 25 and is recorded on a memory (not illustrated). When photographing is finished, the attachment section 40 is detached from the ear opening 12 of the shell 11 of the helmet 10.

To attach the imaging section 20 to the helmet 10, there has been adopted a method in which the imaging section 20 is fixed to the shell 11 with a double-sided tape or an adhesive tape and so on. However, this method suffers from difficulty in secure attachment and deterioration in appearance when the wearer puts on the helmet 10. This method also involves a complicated work, e.g., peeling off the double-sided tape or the adhesive tape and so on after photographing is completed. Further, there remains a peeling trace of the double-sided tape or the adhesive tape and so on, which spoils beauty of the appearance of the shell 11.

One plausible method may be, for example, opening a hole in the shell 11 and fixing the imaging section 20 to the hole by a screw. However, opening a hole in the shell 11 may cause a crack around the hole in the shell 11, leading to a possibility of lowered strength of the shell 11.

On the other hand, in the example embodiment, the attachment section 40 is attached to the ear opening 12 of the shell 11 of the helmet 10. Thus, it is possible to easily attach or detach the imaging section 20 to or from the helmet 10 without deteriorating strength or beauty of the helmet 10.

As described above, in the example embodiment, since the attachment section 40 is detachably attached to the ear opening 12 of the shell 11 of the helmet 10, and the holder section 50 is allowed to hold the object to be mounted, i.e. the imaging section 20, it is possible to facilitate mounting and dismounting the object to be mounted.

Moreover, there is no more complicated work such as fixing the imaging section 20 with a double-sided tape or an adhesive tape and so on or peeling off the double-sided tape or the adhesive tape and so on at each time of photographing. Further, since there remains, on the shell 11, no peeling trace of the double-sided tape or the adhesive tape and so on, it is possible to maintain the shell 11 in a beautiful state for a long time without preparing the helmet 10 only for the purpose of photographing. In addition, since no physical remodeling is made to the shell 11 itself, there is little influence on safety that is intended for the helmet 10 to be provided with. It is therefore possible to obtain an image useful in improving techniques, while allowing a protective function of the helmet 10 to be attained.

Further, in the attachment section 40, the first catching member 41 engages the first ear opening 12L, the second catching member 42 engages the second ear opening 12R, and the first catching member 41 and the second catching member 42 are connected by the connecting member 43. It is therefore possible to attach securely and firmly the attachment section 40 to the helmet 10. Also, there is little possibility of damage to the helmet 10.

In addition, the connecting member 43 is adjustable longitudinally in accordance with the route length L11 on the outer surface of the shell 11, the route length L11 being set from the first ear opening 12L to the second ear opening 12R. Thus, it is possible to cope with a difference in size or in shape of the helmet 10. It is also possible for many people to use the imaging device 1 by mounting the imaging device 1 on the helmet 10 of his or her own.

Furthermore, the holder section 50 holds the object to be mounted, i.e. the imaging section 20, substantially in horizontal alignment LEye with the right eye ER and the left eye EL of the wearer P of the helmet 10. In this way, it is possible to allow the imaging section 20 to be held in horizontal alignment with an eye level of the wearer P, thereby obtaining a picture that is close to the visual field seen by the wearer P. This makes it possible to help the wearer P or a coach to determine, based on the picture, which direction the wearer P is conscious of, when throwing or receiving a ball, which contributes to an improvement in techniques.

### Modification Example 1

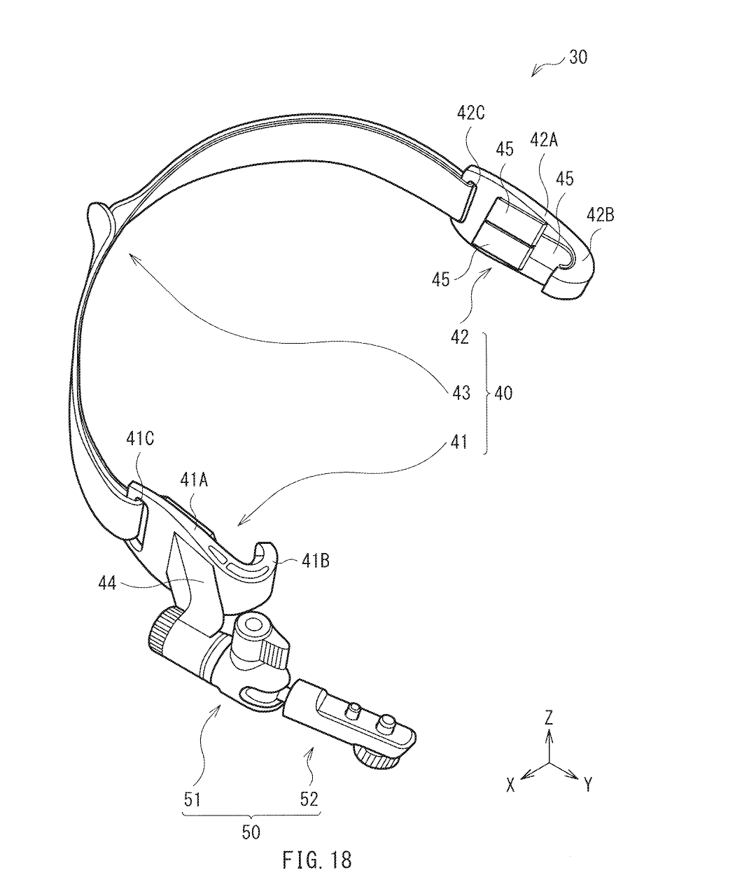

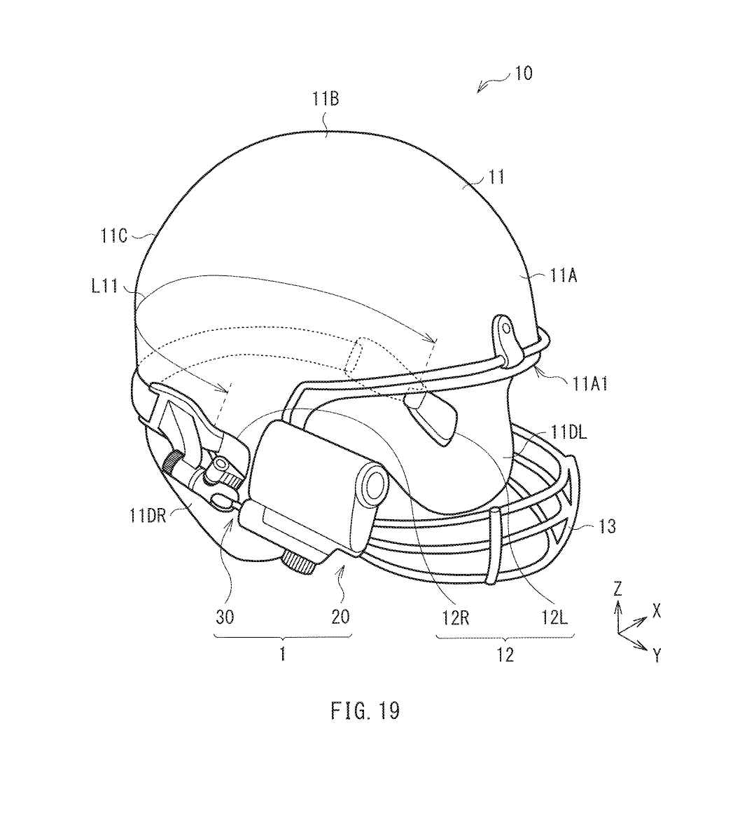

In the example embodiment above, description is given on a case that the first catching member 41 engages the first ear opening 12L on the left side, the second catching member 42 engages the second ear opening 12R on the right side, and the imaging section 20 is held on the left side of the helmet 10. This configuration is suitable for a case that the wearer is right-handed or throws a ball with his or her right hand. On the other hand, in a case that the wearer is left-handed or throws a ball with his or her left hand, as illustrated in FIGS. 18 and 19, preferably, the first catching member 41 engages the second ear opening 12R on the right side, the second catching member 42 engages the first ear opening 12L on the left side, and the imaging section 20 is held on the right side of the helmet 10.

In other words, the first catching member 41 and the second catching member 42 may preferably be switchable with each other to engage the first ear opening 12L and the second ear opening 12R, and the holder section 50 may preferably be connectable to the receiving part 44 of the first catching member 41, regardless of whether the first catching member 41 engages the first ear opening 12L or the second ear opening 12R.

It is to be noted that, in this case, as noted above in the example embodiment, the tubular portion 44B may preferably be provided with two flat portions 44C, and the two flat portions 44C may preferably be provided at facing positions in the circumferential direction. In this way, in a case that the first catching member 41 and the second catching member 42 are switched with each other to engage the first ear opening 12L and the second ear opening 12R, it is possible to allow the holder section 50 to be connected to the receiving part 44 in a right-and-left inverted orientation. Thus, it is possible to restrain the fastening screw 51G of the joint part 51 from interfering with the shell 11 and to avoid damage to the shell 11 due to such interference.

### Modification Example 2

Moreover, in the example embodiment above, description is given on a case that the connecting member 43 is configured of a hook-and-loop fastener. However, the connecting member 43 may have other configurations than a hook-and-loop fastener. Examples may include a dial type reel lock and various kinds of buckles.

### Modification Example 3

Further, in the example embodiment above, description is given on a case that the position of the imaging section 20 in the front-and-rear direction Y is fixed. In the modification example 3, the position of the imaging section 20 is adjusted in the front-and-rear direction Y. The position of the imaging section 20 in the front-and-rear direction Y may influence the visual field of the wearer P or an image to be obtained. When the imaging section 20 is positioned backward, imaging of the face guard 13 may enhance feeling of presence. However, the imaging section 20 retreats too much, there may be a possibility that imaging of the face guard 13 disturbs photographing. On the other hand, when the imaging section 20 is too advanced forward, the imaging section 20 is likely to come into the visual field of the wearer P, which may distract the attention of the wearer P. Since the visual field is related to subjectivity of the wearer P, the position of the imaging section 20 in the front-and-rear direction Y may preferably be adjustable according to a purpose of photographing or preference of the wearer P.

Specifically, the imaging section 20 may preferably be adjustable in position in the front-and-rear direction Y, for example, by about 30 mm. The reason is as follows. Ideally, the position of the lens 22 of the imaging section 20 in the front-and-rear direction Y is aligned with the eyes of the wearer P (as illustrated in FIG. 13. It is to be noted that in FIG. 13, the lens 22 is slightly shifted backward from the eyes of the wearer P for easy understanding). A human visual field has a horizontal expansion as wide as 180° to 230°. By aligning the lens 22 of the imaging section 20 with the eyes of the wearer P in the front-and-rear direction Y, the imaging section 20 is less likely to disturb the visual field. The position of the lens 22 of the imaging section 20 in the front-and-rear direction Y may vary according to the size or the shape of the shell 11 of the helmet 10 on which the imaging device 1 is to be mounted, or to the arrangement of the ear opening 12. Since allowance of about 30 mm is made for the position adjustment of the imaging section 20 in the front-and-rear direction Y, it is possible to align the lens 22 of the imaging section 20 with the eyes of the wearer P in the front-and-rear direction Y irrespective of a difference in size or in shape of the shell 11 or in arrangement of the ear opening 12.

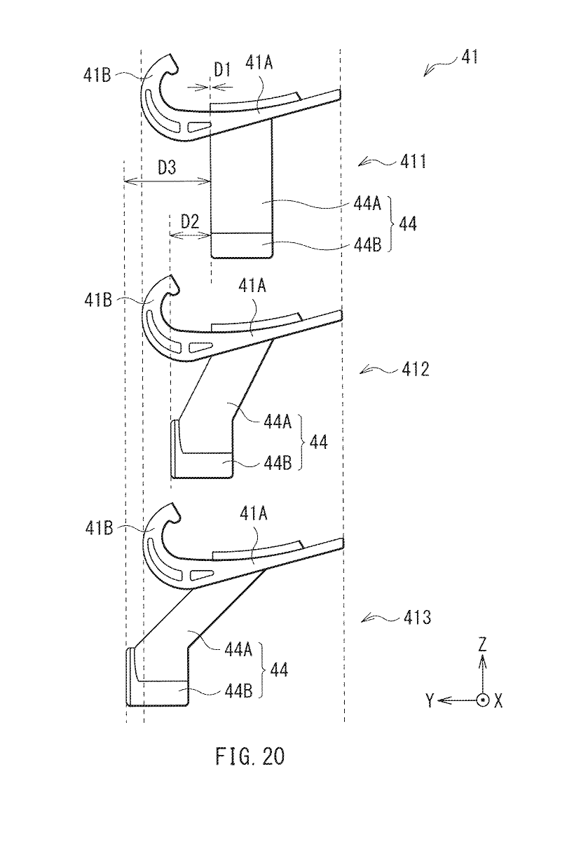

Specifically, as illustrated in FIG. 20, a plurality of (for example, three in FIG. 20) first catching members 411, 412, and 413 having the receiving parts 44 of different shapes may be provided for the position adjustment of the imaging section 20 in the front-and-rear direction Y.

The first catching members 411, 412, and 413 differ in inclination of the arm portions 44A of the receiving parts 44 with respect to the main parts 41A. In the first catching member 411, the arm portion 44A of the receiving part 44 protrudes perpendicularly from the outer surface of the main part 41A; an amount D1 by which the receiving part 44 is protruded forward (a distance from a root of the arm portion 44A to a front end of the tubular portion 44B) is 0 mm. The first catching member 413 is the same as the first catching member 41 in the example embodiment above; an amount D3 by which the receiving part 44 is protruded forward is, for example, 30 mm. In the first catching member 412, an amount D2 by which the receiving part 44 is protruded forward is an intermediate value of the amounts D1 and D3, i.e. for example, 15 mm. By using appropriately the three kinds of first catching members 411, 412, and 413, it is possible to allow the position of the imaging section 20 in the front-and-rear direction Y to be easily adjusted.

### Modification Example 4

In addition, in the example embodiment above, description is given on a case that the holder section 50 is configured to adjust the position of the imaging section 20 in the rotating direction R. In the modification example 4, the holder section 50 is configured to adjust the position of the imaging section 20 in the front-and-rear direction Y as well as in the rotating direction R. This makes it possible to adjust the position of the imaging section 20 more easily.

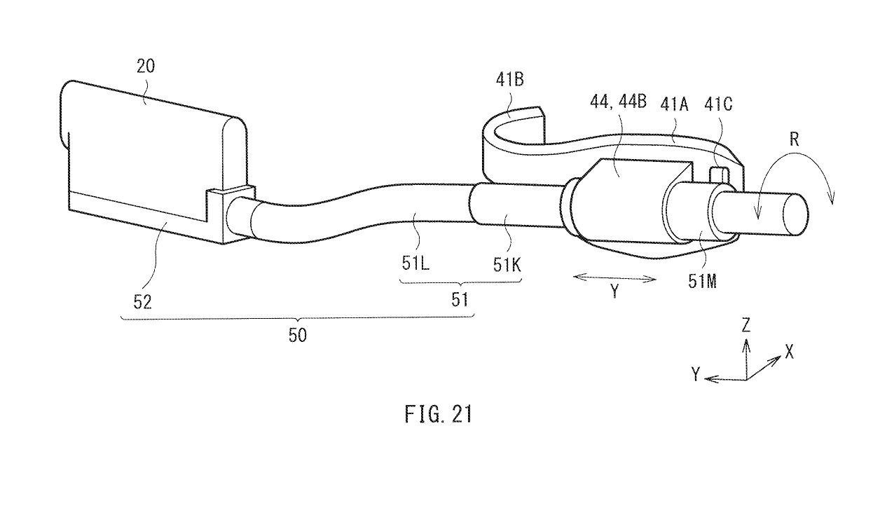

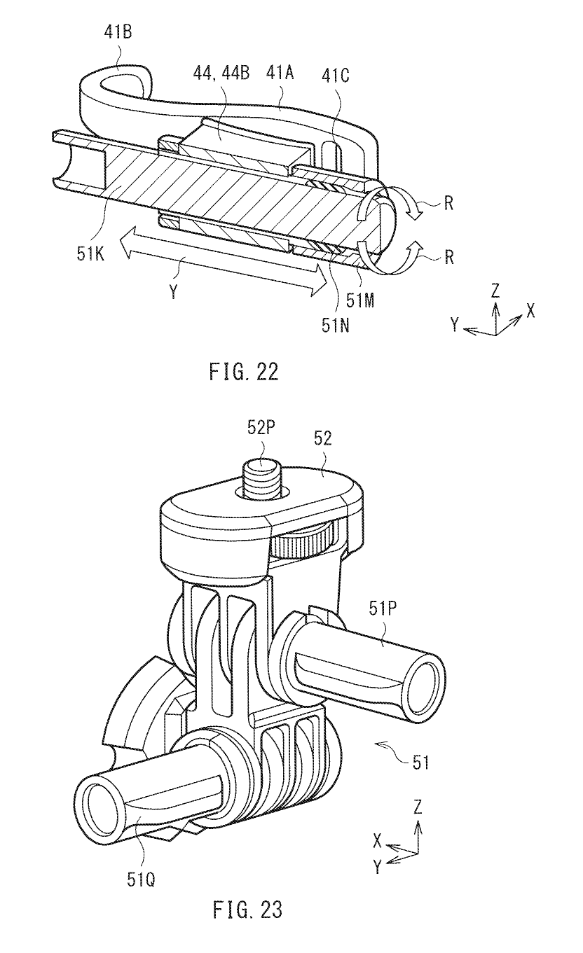

Specifically, as illustrated in FIGS. 21 and 22, the joint part 51 includes a main shaft portion 51K and an adjustment portion 51L.

The main shaft portion 51K is configured to be inserted through the tubular portion 44B of the receiving part 44 and to be fixed to the receiving part 44 by a fastening screw 51M and an O ring 51N. The main shaft portion 51K is allowed to move in the front-and-rear direction Y and in the rotating direction R with the fastening screw 51M loosened. Thus, it is possible for the holder section 50 to adjust the position of the imaging section 20 in the front-and-rear direction Y as well as in the rotating direction R.

The adjustment portion 51L is configured of a flexible tube. A flexible tube is a deflectable tube capable of axial expansion, lateral displacement, and bending displacement, and so on, and is configured of a metal tube, a resin tube, or a rubber tube. Thus, it is possible to allow the position of the imaging section 20 in the rotating direction R or in the front-and-rear direction Y to be freely adjusted by deforming the flexible tube with the fastening screw 51M of the main shaft portion 51K fastened.

It is to be noted that, as illustrated in FIG. 23, the holder section 50 may have a configuration in which the mounting base 52 is disposed on the joint part 51 of common joint type. In the holder section 50, the imaging section 20 is attached to a screw 52P of the mounting base 52. The mounting base 52 is configured to be displaced around two axes with two adjustment knobs 51P and 51Q of the joint part 51, thereby allowing the position of the imaging section 20 to be adjusted in the rotating direction R or the front-and-rear direction Y.

### Modification Example 5

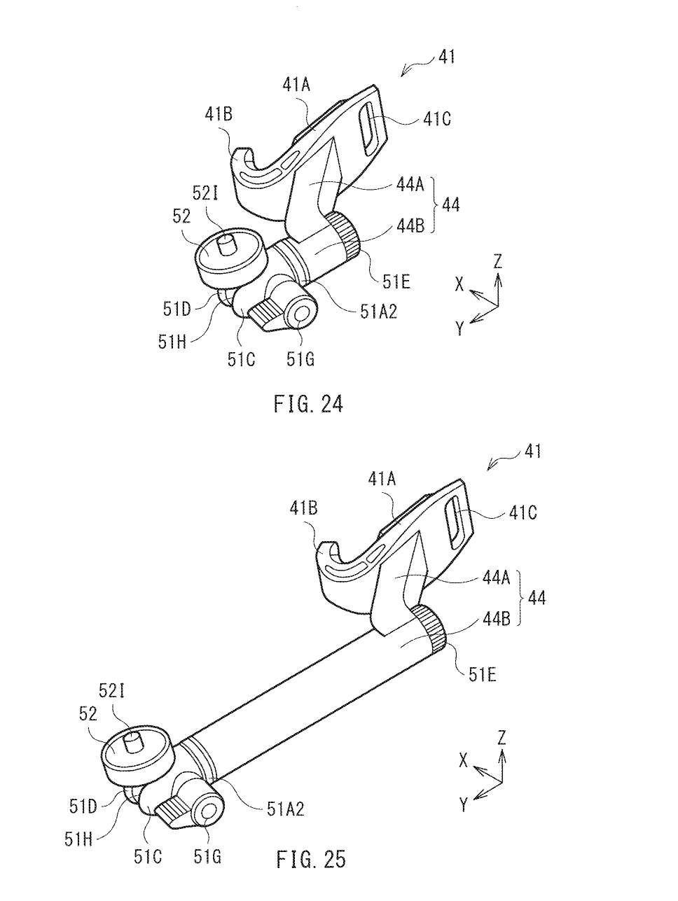

Furthermore, in the example embodiment above, description is given on a case that the mounting base 52 is provided to be extended forwardly from the joint part 51. However, as illustrated in FIG. 24, a mounting base 52 of a disc shape may be disposed on the joint part 51. In this case, the video dowel 52M may be omitted.

In the modification example 5, as illustrated in FIG. 25, the tubular portion 44B of the receiving part 44 of the first catching member 41 may be extended forwardly to compensate a shortened length of the mounting base 52. In this case, similarly to the example embodiment above, it is possible to allow the holder section 50 to hold the imaging section 20 at a slightly advanced position in the front-and-rear direction Y, lowering a possibility that imaging of the face guard 13 disturbs photographing.

### Modification Example 6

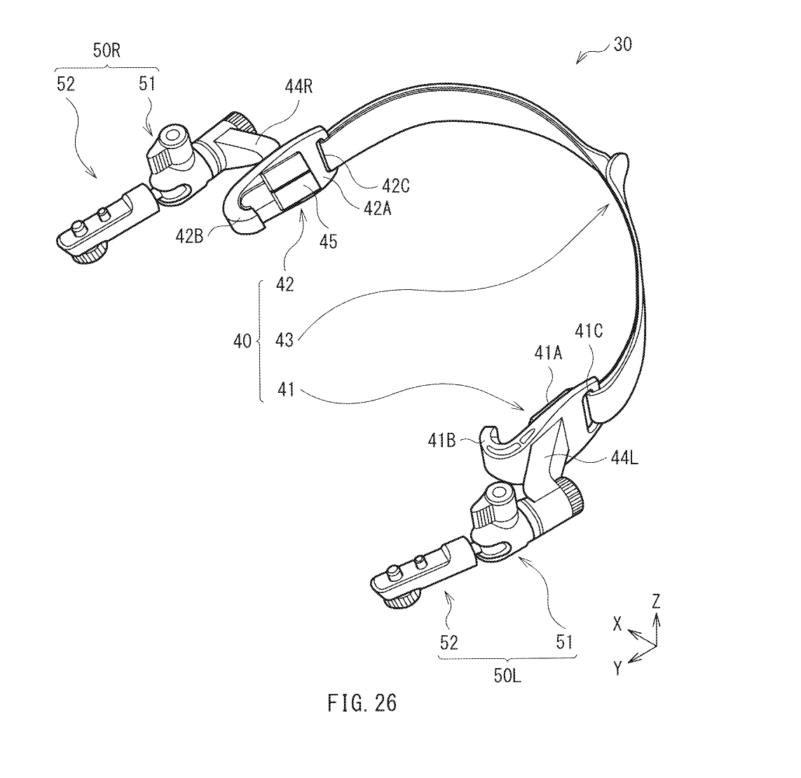

Further in addition, in the example embodiment above, description is given on a case that the mounting section 30 includes one holder section 50. However, as illustrated in FIG. 26, the mounting section 30 may include a first holder section 50L and a second holder section 50R. In this way, it is possible to hold the imaging sections 20 on both the right and the left sides of the helmet 10. This makes it possible to widen a field angle for panorama photographing. Also, 360° photographing or three-dimensional (3D) photographing may be possible.

In this case, the first catching member 41 may preferably include a first receiving part 44L to which the first holder section 50L is configured to be detachably connected. The second catching member 42 may preferably include a second receiving part 44R to which the second holder section 50R is configured to be detachably connected. The first holder section 50L and the second holder section 50R are configured similarly to the holder section 50 as described in the example embodiment above. The first receiving part 44L and the second receiving part 44R are configured similarly to the receiving part 44 as described in the example embodiment above.

### (Mounting Device)

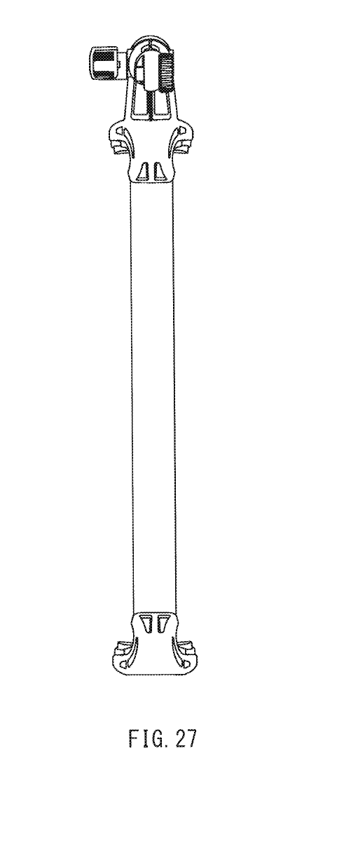

FIG. 27 is a front elevational view of a mounting device according to one embodiment of the disclosure.

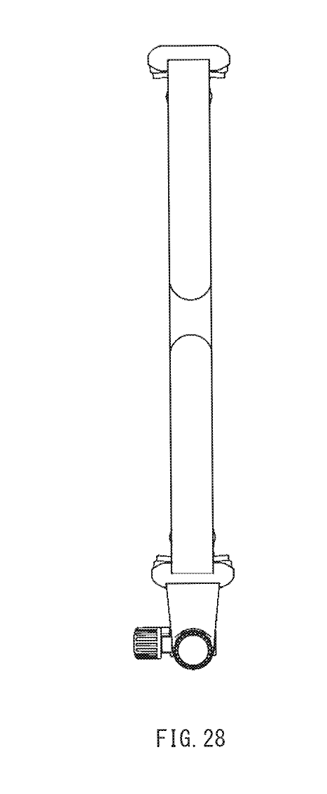

FIG. 28 is a rear elevational view of the mounting device illustrated in FIG. 27.

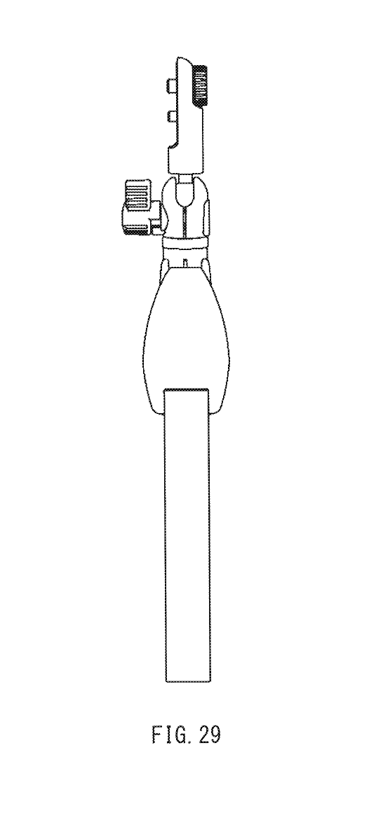

FIG. 29 is a right side elevational view of the mounting device illustrated in FIG. 27.

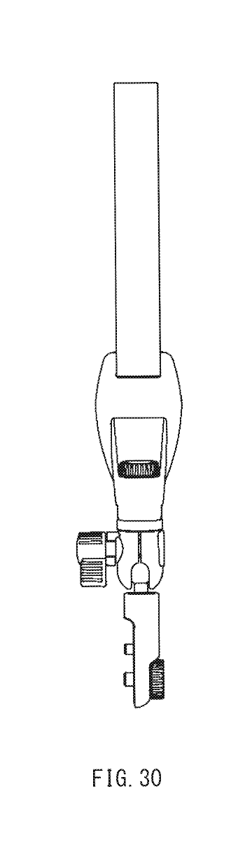

FIG. 30 is a left side elevational view of the mounting device illustrated in FIG. 27.

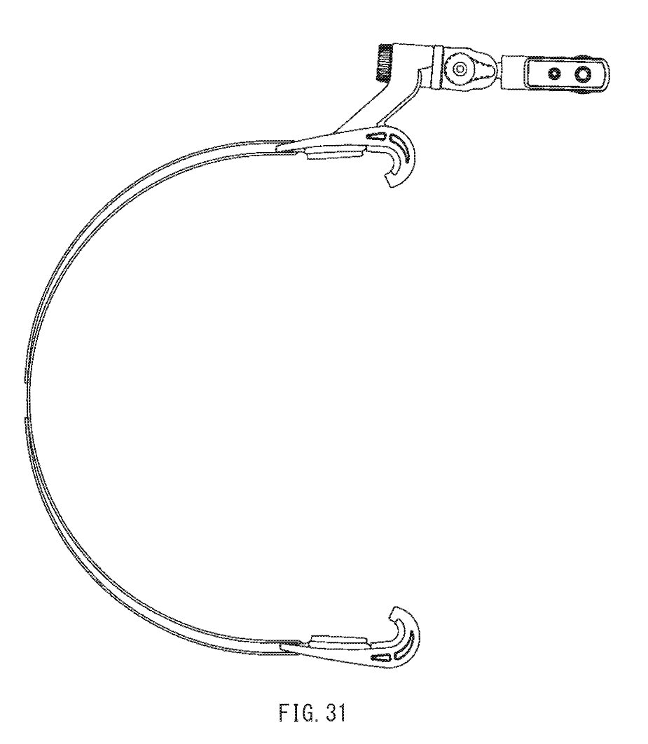

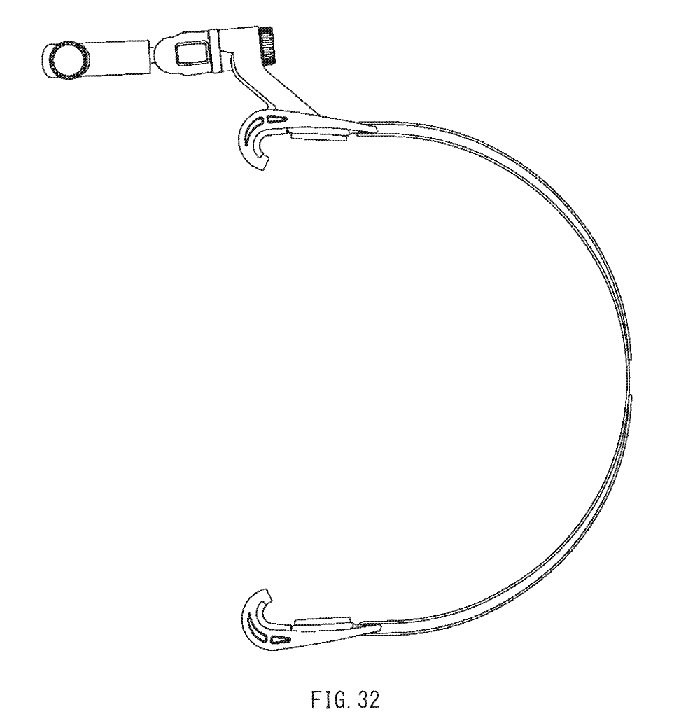

FIG. 31 is a top plan view of the mounting device illustrated in FIG. 27.

FIG. 32 is a bottom plan view of the mounting device illustrated in FIG. 27.

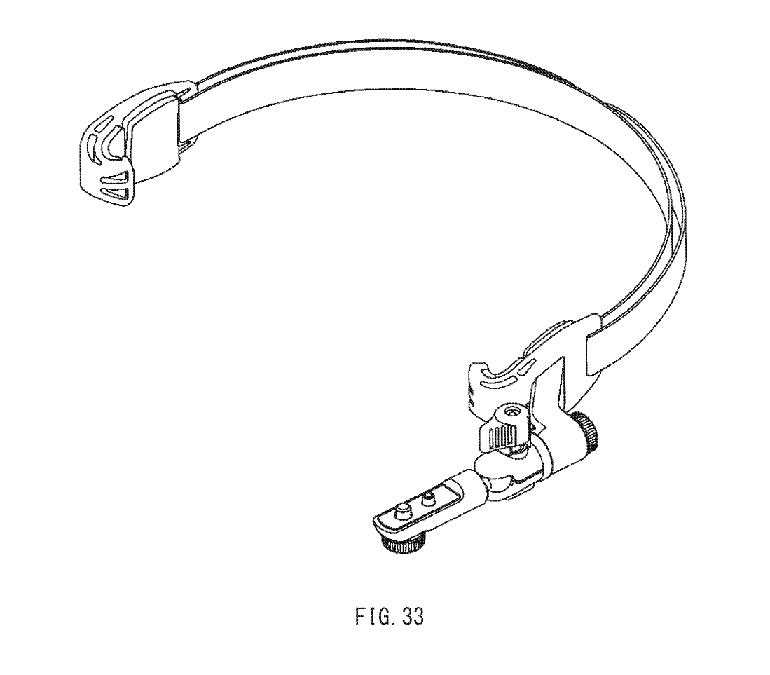

FIG. 33 is a perspective view of the mounting device illustrated in FIG. 27.

Although description has been made by giving the example embodiment as mentioned above, the contents of the present disclosure are not limited to the above-mentioned embodiment and may be modified in a variety of ways. For example, in the above-described example embodiment, description is given on a case that the holder section 50 is configured to be detachably connected to the attachment section 40. However, the holder section 50 may be configured to be fixedly or integrally connected to the attachment section 40.

For example, in the above-described example embodiment, description is given on a case that the attachment section 40 is provided to extend between the first ear opening 12L and the second ear opening 12R of the shell 11. However, the attachment section 40 may be configured to be attached to either the first ear opening 12L or the second ear opening 12R.

Moreover, for example, in the above-described embodiment, description is given on a case that the connecting member 43 is provided to connect the first catching member 41 and the second catching member 42 surrounding the rear portion 11C of the outer surface of the shell 11. However, although not illustrated, the connecting member 43 may be provided to connect the first catching member 41 and the second catching member 42 surrounding the crown portion 11B of the outer surface of the shell 11. Alternatively, although not illustrated, the connecting member 43 may be provided to connect the first catching member 41 and the second catching member 42 surrounding the front portion 11A of the outer surface of the shell 11.

Further, shapes, dimensions, and materials, or manufacturing methods of each component described in the above-described example embodiment are non-limiting, but other shapes, other dimensions, and other materials, or other manufacturing methods may be adopted. For example, the connecting member 43 may include a wiring (not shown) that is provided along part or all of the connecting member 43 in the longitudinal direction. For example, a battery or the like (not illustrated) may be held in the middle of the connecting member 43, and the connecting member 43 may be provided with a wiring (not illustrated) that electrically connects the battery or the like with the imaging section 20. Alternatively, a battery or the like (not illustrated) may be held on the second catching member 42, and the connecting member 43 may be provided with a wiring (not illustrated) that electrically connects the battery or the like with the imaging section 20. Alternatively a speaker (not illustrated) may be arranged on the inner surface of the shell 11, a battery (not illustrated) may be held on the connecting member 43 or the second catching member 42, and the connecting member 43 may be provided with a wiring (not illustrated) that electrically connects the speaker with the battery.

In addition, for example, description is given with specific examples of configurations of the imaging device 1 and the mounting section 30. However, it is not necessary to include all the components described above, and rather a component or components other than the above-mentioned components may be also included.

Furthermore, for example, in the example embodiment above, description is given on a case that the imaging device 1 is mounted on the helmet 10 for sports such as football. However, an object to which the imaging device 1 is to be mounted is not limited to the helmet 10 for sports such as football, as long as the helmet 10 includes a shell 11 provided with the ear opening 12 (the first ear opening 12L and the second ear opening 12R).

Further in addition, for example, in the example embodiment above, description is given on a case that the imaging section 20 is a small-sized camera such as “an action camera.” However, the imaging section 20 may be a video camera or a digital camera in general, that has a size and a weight capable of being mounted by the mounting section 30 as described in the example embodiment above.

Furthermore, for example, in the example embodiment above, description is given on a case that the object to be mounted by the mounting section 30 is the imaging section 20, i.e. a camera. However, the object to be mounted by the mounting section 30 is not particularly limited, and may be a battery, a speaker, a transceiver, a lighting unit, a microphone, a smart phone, a remote controller as well as the imaging section 20. This makes it possible to realize, for example, a camera-and-speaker-composite imaging device.

It is to be noted that the effects described in the above-described embodiments and so forth are merely exemplified and not limitative, and effects of the present disclosure may be other effects or may further include other effects.

It is possible to achieve at least the following configurations from the above-described example embodiments of the technology.

(1) A mounting device, including:

an attachment section configured to be detachably attached to an ear opening of a shell of a helmet; and

a holder section configured to be connected to the attachment section, the holder section being configured to detachably hold an object to be mounted.

(2) The mounting device according to (1),

wherein the ear opening includes a first ear opening and a second ear opening, and

the attachment section includes

a first catching member configured to engage one of the first ear opening and the second ear opening,

a second catching member configured to engage another of the first ear opening and the second ear opening, and

a connecting member configured to connect the first catching member and the second catching member.

(3) The mounting device according to (2), wherein the first catching member includes a receiving part to which the holder section is detachably connected.
(4) The mounting device according to (3),

wherein the first catching member and the second catching member are switchable with each other to engage the first ear opening and the second ear opening, and

the holder section is connectable to the receiving part of the first catching member, regardless of whether the first catching member engages the first ear opening or the second ear opening.

(5) The mounting device according to (3) or (4),

wherein the first catching member and the second catching member each includes

a main part,

a hook part that is provided in a front end of the main part, the hook part being configured to engage the first ear opening or the second ear opening, and

a link part that is provided in a rear end of the main part, the link part being configured to allow the connecting member to connect with the main part, and

the receiving part is provided to protrude from an outer surface of the main part of the first catching member.

(6) The mounting device according to (5), wherein the first catching member and the second catching member each includes a cushion, the cushion being provided on an inner surface of the hook part and on an inner surface of the main part.
(7) The mounting device according to (5) or (6), wherein an inside diameter of the hook part is larger than a thickness of the shell at an edge of the first ear opening or the second ear opening.
(8) The mounting device according to any one of (5) to (7), wherein a width of the hook part is smaller than a width of the main part.
(9) The mounting device according to any one of (3) to (8), wherein the holder section includes

a joint part configured to be detachably connected to the receiving part, and

a mounting base on which the object to be mounted is detachably mounted.

(10) The mounting device according to (9), wherein the holder section is configured to adjust a position of the object to be mounted, in a rotating direction relative to the joint part.
(11) The mounting device according to (9) or (10), wherein the holder section is configured to adjust a position of the object to be mounted, in a front-and-rear direction relative to the joint part.
(12) The mounting device according to any one of (1) to (11), wherein the holder section is configured to hold the object to be mounted, substantially in horizontal alignment with right and left eyes of a wearer of the helmet.
(13) The mounting device according to any one of (1) to (12), wherein the holder section is configured to hold the object to be mounted, in horizontal alignment with a range between a front edge line of the helmet and a lower edge of the helmet.
(14) The mounting device according to any one of (2) to (13), wherein the connecting member is configured to connect the first catching member and the second catching member surrounding a rear portion of an outer surface of the shell.
(15) The mounting device according to any one of (2) to (14), wherein the connecting member is configured to be adjusted longitudinally in accordance with a route length on an outer surface of the shell, the route length being set between the first ear opening and the second ear opening.
(16) The mounting device according to (2),

wherein the holder section includes a first holder section and a second holder section,

the first catching member includes a first receiving part to which the first holder section is detachably connected, and

the second catching member includes a second receiving part to which the second holder section is detachably connected.

(17) The mounting device according to any one of (1) to (16), wherein the object to be mounted is an imaging section.
(18) An imaging device, including:

an imaging section; and

a mounting section,

wherein the mounting section includes

an attachment section configured to be detachably attached to an ear opening of a shell of a helmet; and

a holder section configured to be connected to the attachment section, the holder section being configured to detachably hold the imaging section.

It should be understood by those skilled in the art that various modifications, combinations, sub-combinations and alterations may occur depending on design requirements and other factors insofar as they are within the scope of the appended claims or the equivalents thereof.

What is claimed is:

1. A mounting device, comprising:
an attachment section configured to be detachably attached to an ear opening of a shell of a helmet; and
a holder section configured to be connected to the attachment section, the holder section being configured to detachably hold an object to be mounted.

2. The mounting device according to claim 1,
wherein the ear opening includes a first ear opening and a second ear opening, and
the attachment section includes
a first catching member configured to engage one of the first ear opening and the second ear opening,
a second catching member configured to engage another of the first ear opening and the second ear opening, and
a connecting member configured to connect the first catching member and the second catching member.

3. The mounting device according to claim 2, wherein the first catching member includes a receiving part to which the holder section is detachably connected.

4. The mounting device according to claim 3,
wherein the first catching member and the second catching member are switchable with each other to engage the first ear opening and the second ear opening, and
the holder section is connectable to the receiving part of the first catching member, regardless of whether the first catching member engages the first ear opening or the second ear opening.

5. The mounting device according to claim 3,
wherein the first catching member and the second catching member each includes
a main part,
a hook part that is provided in a front end of the main part, the hook part being configured to engage the first ear opening or the second ear opening, and
a link part that is provided in a rear end of the main part, the link part being configured to allow the connecting member to connect with the main part, and
the receiving part is provided to protrude from an outer surface of the main part of the first catching member.

6. The mounting device according to claim 5, wherein the first catching member and the second catching member each includes a cushion, the cushion being provided on an inner surface of the hook part and on an inner surface of the main part.

7. The mounting device according to claim 5, wherein an inside diameter of the hook part is larger than a thickness of the shell at an edge of the first ear opening or the second ear opening.

8. The mounting device according to claim 5, wherein a width of the hook part is smaller than a width of the main part.

9. The mounting device according to claim 3, wherein the holder section includes
a joint part configured to be detachably connected to the receiving part, and
a mounting base on which the object to be mounted is detachably mounted.

10. The mounting device according to claim 9, wherein the holder section is configured to adjust a position of the object to be mounted, in a rotating direction relative to the joint part.

11. The mounting device according to claim 9, wherein the holder section is configured to adjust a position of the object to be mounted, in a front-and-rear direction relative to the joint part.

12. The mounting device according to claim 1, wherein the holder section is configured to hold the object to be mounted, substantially in horizontal alignment with right and left eyes of a wearer of the helmet.

13. The mounting device according to claim 1, wherein the holder section is configured to hold the object to be mounted, in horizontal alignment with a range between a front edge line of the helmet and a lower edge of the helmet.

14. The mounting device according to claim 2, wherein the connecting member is configured to connect the first catching member and the second catching member surrounding a rear portion of an outer surface of the shell.

15. The mounting device according to claim 2, wherein the connecting member is configured to be adjusted longitudinally in accordance with a route length on an outer surface of the shell, the route length being set between the first ear opening and the second ear opening.

16. The mounting device according to claim 2,
wherein the holder section includes a first holder section and a second holder section,
the first catching member includes a first receiving part to which the first holder section is detachably connected, and
the second catching member includes a second receiving part to which the second holder section is detachably connected.

17. The mounting device according to claim 1, wherein the object to be mounted is an imaging section.

18. An imaging device, comprising:
an imaging section; and
a mounting section,
wherein the mounting section includes
an attachment section configured to be detachably attached to an ear opening of a shell of a helmet; and
a holder section configured to be connected to the attachment section, the holder section being configured to detachably hold the imaging section.
